(19) United States
(12) Patent Application Publication
(10) Pub. No.: US 2006/0258496 A1
(43) Pub. Date: Nov. 16, 2006

(54) Transmission mechanism for dental impression material mixer

(76) Inventor: Shu-Lung Wang, Taipei Hsien (TW)

Correspondence Address: BIRCH STEWART KOLASCH & BIRCH, PO BOX 747, FALLS CHURCH, VA, 22040-0747, US

(21) Appl. No.: 11/125,192

(22) Filed: May 10, 2005

(51) Int. Cl. F16H 7/08; F16H 7/14

(52) U.S. Cl. 474/101; 474/134; 474/117

(57) ABSTRACT

An improved transmission mechanism for dental impression material mixer mainly comprises a plurality of pulleys and at least two belts, wherein the belts are circled round the pulleys and then activate by a motor, so as to allow a chamber and a housing cup on a V-shape supporting frame to rotate in a reverse direction. Furthermore, the present invention provides at least one additional pressing device for the transmission mechanism, which can be continuously pressing on the belt, so as to prevent the belt to separate from the pulley during high-speed rotation and maintain a smooth stirring operation for the mixer.

### FIELD OF THE INVENTION

The present invention relates to a transmission mechanism for dental impression material mixer and, more particularly, to an improved transmission mechanism which can prevent the belts separating from the pulleys under a high-speed operation.

### BACKGROUND OF THE INVENTION

In the practice of dentistry, a cast or a mold must be made according to the profile of the patient's teeth during the manufacturing of dentures, and then the dentures are formed according to the cast. The ingredients of the above stated cast are generally chosen from impression materials or plaster. After adding water to these ingredients, the whole mixture is then stirred manually until it becomes a sticky texture for further utilization. Since the above mixture will solidify and set within a period of time, therefore, owing to the time constraints for manual stirring, the impression materials usually cannot be mixed evenly. Furthermore, the way of stirring manually is quite strenuous and will cause the mixture to form air bubbles, thus causing the cast to remain air holes within and results in a rough surface. This defect will greatly affect the product quality of the dentures.

Since the stirring method for dental impression materials is basically manual, therefore, in order to solve the above defect, the conventional technology has already disclosed a special mixer for mixing the dental impression materials. Such mixer is mainly developed by the assistance of a transmission device. When the internal motor of the mixer starts, it allows a chamber and a housing cup, which are axially mounted on a v-shape frame body, to rotate in a reverse direction, so as to fulfill the objective of mixing the impression materials. It is worth mentioning that, the existing transmission device is mainly utilizing a plurality of planetary gears meshing each other (Please refer to R.O.C. Patent Publication No. 274741 which discloses a mixer for impression materials.), or perhaps by using belt to circle round several pulleys so as to achieve a mixing function. However, in the practice of the above belt and pulleys transmission device design, the belt will easily be separated from the pulleys under a high-speed rotating operation, thus affecting the stirring operation of the mixer.

### SUMMARY OF THE INVENTION

It is a primary object of the present invention is to provide an improved transmission mechanism for dental impression material mixer, which can prevent the belts separating from the pulleys under a high-speed operation.

In order to achieve the foregoing objects, the transmission mechanism of the present invention is constructed by a plurality of pulleys, at least two belts and a pressing device. Wherein, the belts are circled round the pulleys and then activates by a motor, so as to allow a chamber and a housing cup on a V-shape supporting frame to rotate in a reverse direction. The pressing device comprises of a comprises of a pressing pulley, a shaft and a holding part. The holding part is equipped on the V-shape supporting frame, and the shaft is mounted on the holding part. The pressing pulley is axially mounted on the shaft and continuously presses on the belt, so as to prevent the belt to separate from the pulley during high-speed rotation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a side view of the improved transmission mechanism for dental impression material mixer of the present invention assembled on a mixer.

FIG. 2 is an exploded view of the pressing device of the improved transmission mechanism for dental impression material mixer of the present invention.

FIG. 3 is a top perspective view of the improved transmission mechanism for dental impression material mixer of the present invention assembled on a mixer.

FIG. 4 is a side view of the improved transmission mechanism for dental impression material mixer of the present invention being assembled on another type of mixer, wherein it is specially illustrated that the anti-vibration mechanism of the mixer is having elastic springs that are linked to the top and the bottom portion of the motor.

### DESCRIPTION OF THE PREFERRED EMBODIMENTS

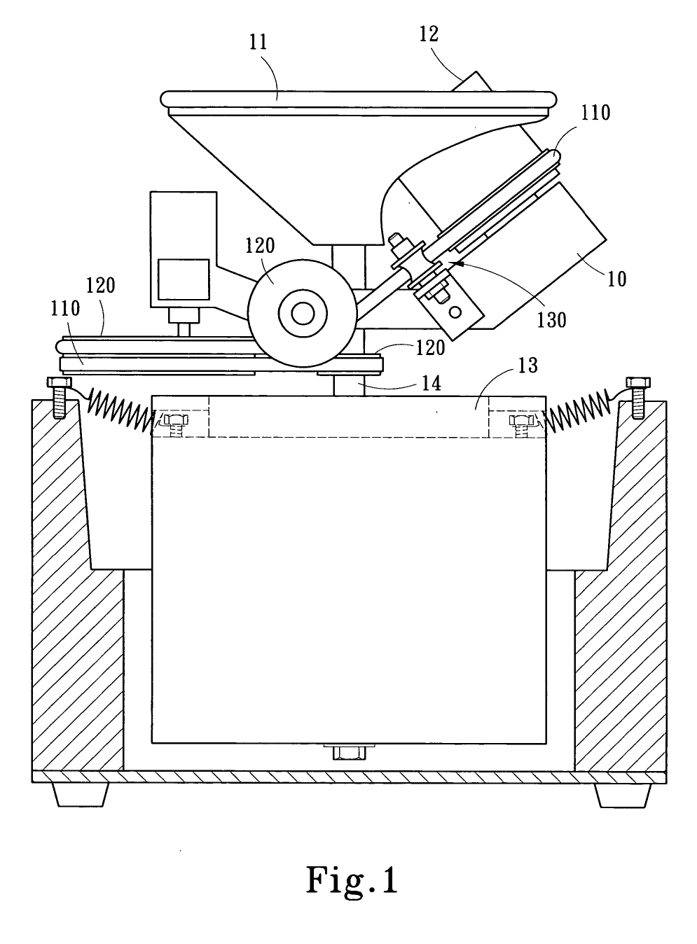

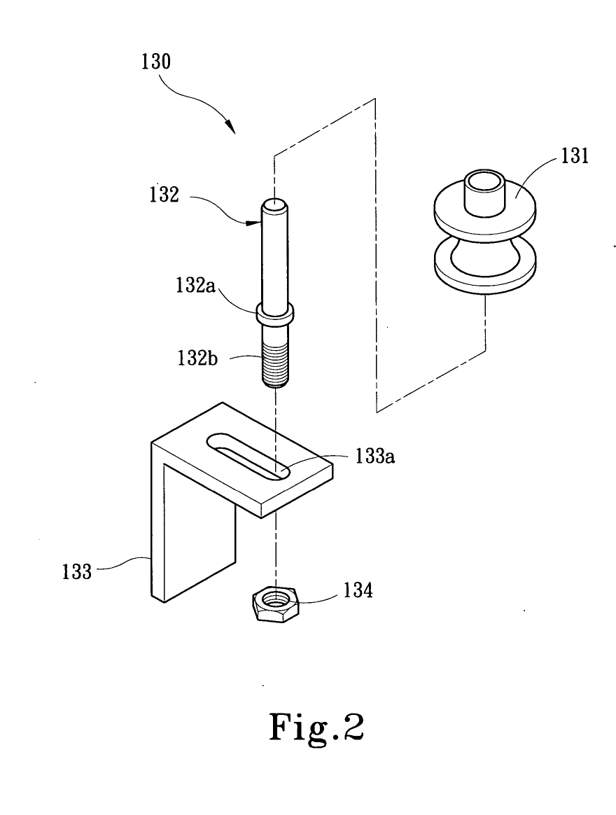

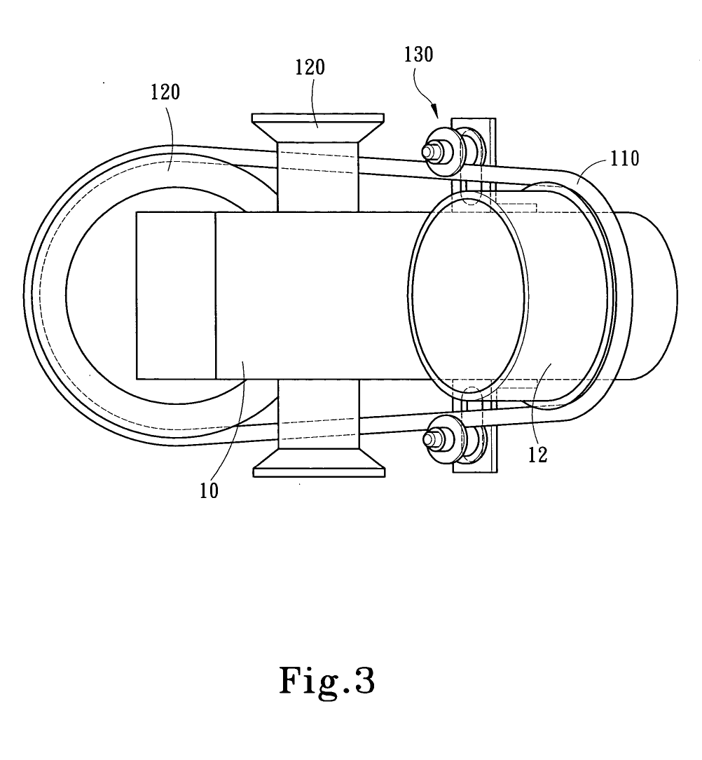

To start with, please refer to FIGS. 1, 2 and 3. An improved transmission mechanism for dental impression material mixer of the preferred embodiment of the present invention, mainly constructed by two belts 110, a plurality of pulleys 120 and a pressing device 130. Wherein, the above pulleys 120 are axially mounted on a V-shape supporting frame 10. The supporting frame 10 further includes a chamber 11 and a housing cup 12 that are located inside the chamber 11. And the V-shape supporting frame 10 is axially mounted on a rotating shaft 14 of a motor 13. The two belts 110 are circled round the pulleys 120, and one of the above belts 110 further circles around the housing cup 12. When the motor 13 starts its operation, the rotating shaft 14 of the motor 13 will activate the V-shape supporting frame 10 to rotate. And through the coupling transmission of the belts 110 and the pulleys 120 activating each other, it allows the chamber 11 and the housing cup 12 on the V-shape supporting frame 10 to rotate in a reverse direction. The pressing device 130 comprises of a pressing pulley 131, a shaft 132 and a holding part 133. The holding part 133 is equipped on the V-shape supporting frame 10, and the shaft 132 is mounted on the holding part 133. The pressing pulley 131 is axially mounted on the shaft 132 and continuously presses on the belt 110, so as to prevent the belt 110 to separate from the pulley 120 during high-speed rotation. In the present preferred embodiment, the holding part 133 can be a L-shape plate, and a sliding notch 133a is opened on the holding part 133. The middle segment of the shaft 132 consists of a positioning ring 132a. The positioning ring 132a can be trapped within the sliding notch 133a. The outer surface below the positioning ring 132a of the shaft 132 consists of threads 132b, which can be fastened by a nut 134, so that the position of the shaft 132 can be fixed on the holding part 133. Apart from the above stated, the sliding notch 133a of the holding part 133 can be a long notch, the elongating direction of such sliding notch 133a is designed to be perpendicular to the elongating direction of the belt 110. During assembly, the shaft 132 can be fixed at different positions within the sliding notch 133a, so as to adjust the position of the pressing pulley 131 correspondingly and adjust the strength of the pressing pulley 131 being exerted on the belt 110. In addition, please refer specially to FIG. 3. In the preferred embodiment of the present invention, there are two sets of pressing device 130 which are pressed respectively on the belt 110 that is circled round the housing cup 12. Nevertheless, it is well known to those familiar with the above technique that the number of the additional pressing devices 130 on the transmission mechanism of the present invention are not need to be limited. One to several pressing devices 130 can be mounted adjacent to a single belt 110 depending on the practical demand. Or, one to several pressing devices 130 can be mounted adjacent to a plurality of belts 110.

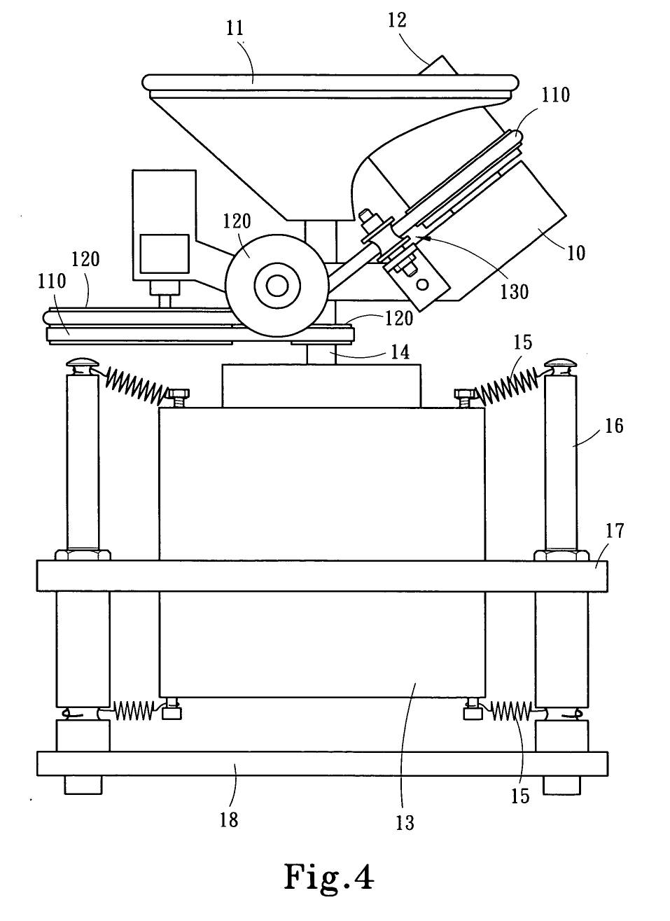

In addition, the dental impression material mixer of the above embodiment, the transmission mechanism is operated along with an anti-vibration mechanism that consists of an elastic spring 15. And the elastic spring 15 is linked to the top portion of the motor 13. Nevertheless, it is well know to those familiar with the above technique that, the transmission mechanism of the mixer of the present invention is not limited to only operate with the above specific kind of anti-vibration mechanism. Another kind of anti-vibration mechanism can be used in the above mixer will be: The elastic springs 15, linking to the top and the bottom portions of the motor 13, is utilized together with a plurality of supporting pole 16, a restricting board 17 and a base plate 18, illustrated on FIG. 4.

To sum up, the improved transmission mechanism for dental impression material mixer, is mainly developed by adding at least one pressing device 130 to be mounted on the transmission mechanism. And allowing the pressing device 130 to be continuously pressed on the belts 110, so as to prevent those belts 110 separating from the pulleys 120 under a high-speed operation, thus maintaining a smooth stirring operation for the mixer.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. An improved transmission mechanism for dental impression material mixer comprises at least a plurality of pulleys and at least two belts, wherein, the belts are circled round the pulleys and then activates by a motor, so as to allow a chamber and a housing cup on a V-shape supporting frame to rotate in a reverse direction, characterized by:
the transmission mechanism further comprising at least one pressing device and the pressing device includeing a pressing pulley, a shaft and a holding part, wherein the holding part is equipped on the V-shape supporting frame, and the shaft is mounted on the holding part, the pressing pulley is axially mounted on the shaft and continuously presses on the belt, so as to prevent the belt to separate from the pulley during high-speed rotation.

2. The improved transmission mechanism for dental impression material mixer according to claim 1, wherein the holding part has a sliding notch, the middle segment of the shaft consists of a positioning ring, the positioning ring can be trapped within the sliding notch, and the outer surface below the positioning ring of the shaft consists of threads, which can be fastened by a nut, so that the position of the shaft can be fixed on the holding part.

3. The improved transmission mechanism for dental impression material mixer according to claim 2, wherein the sliding notch of the holding part is a long notch, and the shaft can be fixed at different positions within the sliding notch, so as to adjust the position of the pressing pulley correspondingly.
